(19) United States
(12) Patent Application Publication
(10) Pub. No.: US 2020/0122100 A1
(43) Pub. Date: Apr. 23, 2020

(54) CANNABINOID INFUSION AND BEVERAGE CARBONATING SYSTEM WITH REMOVABLE FLAVOR PODS

(71) Applicant: David M. Tumey, Coral Springs, FL (US)

(72) Inventor: David M. Tumey, Coral Springs, FL (US)

(73) Assignee: Bluegrass Farmaceuticals, LLC, Belton, KY (US)

(21) Appl. No.: 16/576,684

(22) Filed: Sep. 19, 2019

Related U.S. Application Data
(60) Provisional application No. 62/787,064, filed on Dec. 31, 2018.
(60) Provisional application No. 62/747,191, filed on Oct. 18, 2018.

(51) Int. Cl. B01F 3/04; B65D 85/804; A47J 31/40

(52) U.S. Cl. CPC B01F 3/04808; B65D 85/8046; B01F 2215/0022; B01F 2003/049; A47J 31/407

(57) ABSTRACT

A home carbonation system for producing cannabinoid-infused beverages is described. A high-pressure CO₂ vessel has a regulator valve assembly interconnected via a fill hose to a seltzer dispenser having an infusion valve, plastic bottle with sealable cap, siphon tube, pressure inlet, solenoid actuated pressure relief valve and motor-driven air pump. A syrup flavor cannabinoid pod operably connects to the bottle and enables the making of desired cannabinoid soda flavor soda. A storage rack is provided.

### FIELD OF THE INVENTION

The present general inventive concept relates to an in-home soda machine for preparing cannabinoid-infused carbonated beverages. More particularly, the present general inventive concept is directed to an integrated, self contained system for first generating carbonated water by charging a seltzer system, and thereafter infusing water-soluble cannabinoids while dispensing and mixing the seltzer with a syrup concentrate contained in a removable pod to produce desired cannabinoid-infused carbonated beverages.

### BACKGROUND OF THE INVENTION

The small kitchen appliance market is replete with a variety of carbonation systems for preparing and dispensing carbonated beverages. A wide variety of devices are known for carbonating or charging seltzer arrays for use in commercial establishments such as restaurants and taverns, and many devices aimed at the home market exist, e.g., SodaStream®. The generally complex and expensive commercial systems used in service establishments are impractical for use in a typical home kitchen. For example, known commercial systems are bulky, overly complex and prohibitively expensive. Usually their installation requires tradesmen such as electricians or plumbers. For these and other reasons the desirability of a practical carbonation system for home use has been recognized in the past, and a number of previously issued patents relate to such equipment.

For example, U.S. Pat. No. 4,298,551, issued Nov. 3, 1981, to Adolfsson, describes a home appliance for making aerated beverages. It comprises a casing which interiorly mounts a pressurized carbon dioxide vessel for suitably pressurizing an adjacently disposed seltzer bottle to be charged. Suitable nozzle apparatus is incorporated between the high pressure vessel and the seltzer bottle, which must be mounted within a special casing compartment prior to charging. An elongated nozzle projects into the interior of the seltzer bottle for conducting gas into the bottle interior by first bubbling it through a previously determined volume of water.

U.S. Pat. No. 3,953,550, issued Apr. 27, 1976, to Gilbey, likewise depicts a casing in which the high pressure carbon dioxide vessel is mounted within the casing adjacent to a compartment into which a bottle to be charged is inserted. Valve apparatus directs high pressure carbon dioxide to an input nozzle assembly, which is physically mated with the bottle by a lower cam-lock system which impels the bottle into sealing engagement with the filler for subsequent pressurization. In this device, as well as the previously discussed device, the bottle to be charged must be carefully inserted and then withdrawn from the device casing. When withdrawn, the bottle is vented to atmosphere. The latter reference also teaches the use of a safety shield device separate from the carbonated beverage container, which is adapted to provide protection in the event of inadvertent overcharging and over-pressurization.

U.S. Pat. No. 2,805,846, issued to Dewan on Sep. 10, 1957 discloses a portable beverage charging device essentially comprising a pair of generally tubular shells which mate together around a bottle to be charged. When the shells are mated together the bottle is in effect enshrouded within the shells, and the gas is delivered from a gas cylinder disposed in the reduced diameter neck of the upper shroud. When the shells are forcibly impelled together gas flow begins. After initial charging the enshrouded bottle may be vigorously shaken by the user, prior to removal by subsequent disassembly of the shroud elements. This carbonator device is also adapted to prevent over-pressurization and undesired, potentially harmful release of gas.

U.S. Pat. No. 4,294,410, issued to Gueret, on Oct. 13, 1981, discloses a closure device for a pressurized container. This reference is presumed to be more relevant to the infusion valve associated with the present general inventive concept to be hereinafter described. Sealing caps or closures seen in the following U.S. Pat. Nos. are presumed to be less relevant to the present general inventive concept: U.S. Pat. Nos. 4,295,583; 4,295,584; 4,294,370; 4,294,369; 4,294,367; and 4,294,368.

Unfortunately, the above described devices are characterized by a number of commercially adverse aesthetic and utilitarian deficiencies. From a consumer products safety standpoint the valve inter-coupling structure between the high pressure vessel and the seltzer bottle to be thereafter charged must be extremely reliable. Because of these safety considerations, prior art devices of the enclosure or casing type tend to be generally bulky and heavy. Also, such devices require that the seltzer bottle be inserted and clamped within an adjacent casing, resulting in extra steps and an inconvenience to the operator.

All of the known prior art home dispensing systems are deficient in that once the carbonated water is charged, the cap of the seltzer container is removed. Such venting will, of course, dissipate the former gas pressure head. This degradation of the CO₂ charge has been a recognized consumer objection to such systems. When the bottle or can top is removed for partial consumption of the contents, the carbonation level begins to dissipate rapidly, and the contents are degraded. When the cap is repeatedly removed and replaced, the problem is further aggravated. Even though the first helping of soda water mixed with cannabinoids and syrup is appropriately carbonated, unconsumed water stored in the vessel will tend to slowly lose its charge to atmosphere, even if it is recapped between servings. In addition, when the output of such open seltzer bottles is directed into a glass, the low liquid pressure of the output stream does not facilitate vigorous syrup mixing. Therefore stirring is usually mandated, and that further degrades the quality of the carbonated beverage produced.

A further problem with existing systems is that the seltzer bottle is forcefully clamped or pushed into temporary abutment with the internally captivated valve system. This necessitates the use of a relatively rigid seltzer bottle usually comprised of glass or thick plastic. The shatter-proof housing used for safety purposes results in a slow, inconvenient system. Even where a rigid compartmentalized housing is not employed, a somewhat disorganized combination of working components results. For example, the carbonator vessel can be difficult and cumbersome to store, and when the device is used, particularly by children who desire more than one flavor, a sticky, syrupy mess can often result. These and other disadvantages have been found to present a prohibitive sales and commercialization hurdle.

It is therefore proposed to eliminate the above referenced problems, and to provide a home cannabinoid-infused carbonated beverage system which presents an orderly and aesthetically appeasing array of components that function together to efficiently and safely provide a convenient system for producing cannabinoid-infused carbonated beverages of a variety of flavors. And, it is likewise highly desirable to provide a home carbonation system which is designed throughout to maintain high carbonation levels, while preserving a substantial margin of safety for the consumer.

### SUMMARY OF THE INVENTION

The present general inventive concept comprises an integrated system, ideally adapted for use in the home, for producing carbonated water by charging an associated seltzer bottle then subsequently utilizing removable self-mixing flavor pods to create a cannabinoid-infused carbonated beverage of a desired flavor.

The system incorporates a conventional high pressure vessel filled with carbon dioxide gas. A unique integrated regulator and output valve assembly associated with the vessel is adapted to be coupled by an elongated fitting-equipped flexible cable to a seltzer bottle equipped with an infusion valve. The system also comprises a plurality of removable syrup flavor pods, each comprising internal proportional mixing elements and prefilled with a different flavor of concentrate, enable the mixing of desired soda flavors. A convenient storage rack, adapted to be disposed upon the kitchen counter, for example, stores the pressure vessel, the soda bottle, and removable flavor pods. In the best mode, the removable flavor pods are disposed in orderly rows upon the rack, and the pressure vessel and seltzer bottle are stored in an ergonomic and aesthetically pleasing enclosure. The enclosure may be disposed within the rack immediately adjacent the removable flavor pods for ease in manipulation and storage by the user.

Reduced pressure carbon dioxide gas is obtained from the high pressure vessel through an integrated multi-function regulator valve assembly. The valve assembly preferably comprises a rigid two-piece, generally tubular housing threadably coupled to the pressure vessel, which receives high pressure gas. A transverse passageway defined through the bottom housing portion in fluidic communication with an internal passageway establishes a high pressure fill orifice for recharging the vessel, and a safety vent for dissipating inadvertent high pressure. The top housing portion of the regulator valve assembly is threadably coupled to the bottom housing portion, and the two housing portions captivating an internal regulator piston whose larger diameter head is disposed in the top housing of the regulator, and whose reduced diameter stem is slidably fitted to a passageway in the bottom portion. A low pressure output valve secured at the top of the front housing enables low pressure gas to be transmitted out of the vessel via the resilient quick connect hose coupling.

In the best mode the soda dispenser comprises a transparent plastic bottle optionally reinforced by a two-piece antifragmentation shroud. The infusion valve is threadably coupled to the reduced diameter neck of the bottle, and it includes a gas inlet orifice adapted to be coupled to the quick-connect hose for receiving low pressure gas from the regulator assembly. In addition, the infusion valve includes a pressure inlet, solenoid actuated pressure relief valve, and motor-driven air pump to enable CO₂ infusion and subsequent dispensing and mixing of carbonated beverages. Inspection slots defined in the optional shroud enable the user to first fill the seltzer bottle to a desired level. Gas admitted into the infusion valve during charging is conducted internally to the bottle beneath the liquid level by an internal siphon tube and the vigorous bubbling which results is visible through the inspection slots. The preferred shroud, in combination with the bottle thicknesses, enables over-pressure to be quickly and non-destructively vented safely in the unlikely event of a failure.

With the present general inventive concept, the infusion valve need not be removed from the container for subsequent dispensing of carbonated soda. An electrically actuated motor-driven air pump is employed to create an internal gas pressure head to dispense the liquid through the siphon without removing the bottle cap. Fluid is subsequently dispensed under pressure through the removable flavor pods whereupon it is mixed with syrup concentrate and/or water-soluble cannabinoids exiting through an adjacent output tube, and into the user's glass or container. The infusion valve includes an electrically actuated solenoid pressure relief valve for rapidly reducing head pressure after the seltzer water is dispensed. The soda bottle charging and infusion/dispensing functions are thus combined in the unique infusion valve. Pressurized soda will thus be vigorously outputted whenever the electrical actuator is depressed, in response to the pressure head from the internally confined gas upon the liquid surface therewithin.

A high carbonation level is also facilitated by properly configuring a diffuser assembly, preferably located at the bottom end of the siphon tube, and the orifice at the bottom end of the seltzer infusion valve. Orifice sizes are chosen to reduce the amount of scrubbing the liquid experiences during dispensing.

Preferably each of the removable syrup concentrate flavor pods are of generally cylindrical proportions, and they are made of biodegradable plastic. A suitable fluid connecting element on the pod removably mates with a fluid connecting element on the enclosure to permit the communication of fluid from the seltzer bottle to the removable pod. Internal fluidic elements incorporated in the pod provide means for mixing the syrup concentrate and/or water-soluble cannabinoids in the proper ratio. An adjacent output tube directs the mixture into a glass or container. When use of the seltzer dispenser and/or the removable flavor pods is terminated, everything may be conveniently stored in the aesthetically pleasing rack, which itself may be deployed in a convenient, out-of-the-way position upon a kitchen counter or the like.

Thus, a fundamental object of the present general inventive concept is to provide an integrated, user friendly cannabinoid-infused carbonated beverage dispensing system for home use.

A basic object of the present general inventive concept is to provide an integrated home beverage system of the type described, which while being aesthetically pleasing, gives the user a broad range of beverages in a compact, convenient manner without storage or operating problems.

Yet another object of the present general inventive concept is to provide a fail-safe pressure regulating assembly for the high pressure gas vessel needed in such a system.

A similar object is to provide a system which neatly and conveniently stores the high pressure vessel, as well as the other components of the system.

Yet another object of the present general inventive concept is to provide a home cannabinoid-infused carbonated beverage production system of the type described, whose seltzer bottle need not be vented for subsequent seltzer discharge.

A still further object of the present general inventive concept is to provide a consumer-safe seltzer bottle suitable for use in home soda systems.

Yet another object of the present general inventive concept is to provide a reinforcement safety system for the seltzer bottle. It is a feature of the present general inventive concept that the optional two-piece shroud not only protects the seltzer bottle in the event of unlikely failure, but it is equipped with inspection slots which aid the user in properly charging and thereafter depleting the bottle.

A still further object of the present general inventive concept is to provide a convenient plurality of removable flavor pods containing syrup concentrate and/or water-soluble cannabinoids which may be quickly and easily used, and thereafter stored in a convenient, aesthetically pleasing manner.

A similar object is to provide a home cannabinoid-infused carbonation system of the type described which vigorously carbonates water without significant user shaking of the seltzer bottle, depending on the carbonation level desired.

Another object of the present general inventive concept is to provide a storage rack for the above described components of a home soda fountain system.

Another basic object of the present general inventive concept is to provide a seltzer bottle of the type described, which, virtually immediately after charging, is capable of dispensing seltzer and vigorously mixing flavored syrup concentrate and/or water-soluble cannabinoids into an awaiting container for consumption.

Another fundamental object of the present general inventive concept is to provide a home soda system of the type described which conveniently and inexpensively will produce a multiplicity of cannabinoid-infused carbonated beverages.

Another important object is to provide a home soda system of the type described which can be easily used without creating the annoying messes characteristic of known existing systems.

It is also an important object to provide a system of the type described which minimizes operational failures. Even if a failure does inadvertently occur, it is a feature of the present system that failures may be easily diagnosed and repaired by the user, practically without instruction.

These and other objects and advantages of the present general inventive concept, along with features of novelty appurtenant thereto, will appear or become apparent in the course of the following descriptive sections.

### BRIEF DESCRIPTION OF THE DRAWINGS

FIG. 1 is a front perspective view of the best mode with the components thereof removed from the preferred rack system;

FIG. 2 is a cutaway perspective view of the system similar to FIG. 1, showing various internal components and arrangements thereof;

FIG. 3 is a perspective view of the arrangement for temporary storage in an orderly fashion in the preferred rack system;

FIG. 4 is an enlarged, top plan view of the empty rack of FIG. 3;

FIG. 5 is an enlarged, exploded, fragmentary, perspective view of the system, with certain portions thereof shown in section for clarity or omitted for brevity;

FIG. 5A is a perspective view of the carbon dioxide gas supply, with certain portions thereof shown in phantom lines for clarity or omitted for brevity;

FIG. 6 is a fragmentary, exploded perspective view of the high pressure vessel and the regulator valve assembly;

FIG. 7 is a bottom perspective view of the regulator valve assembly bottom member;

FIG. 8 is a bottom perspective view of an opposite side of the regulator valve assembly bottom housing;

FIG. 9 is an upward side perspective view of the high pressure relief fitting;

FIG. 10 is an inverted side perspective view of the high pressure relief fitting of FIG. 9 with portions thereof omitted for clarity;

FIG. 11 is an upward side perspective view of the high pressure fill valve;

FIG. 12 is an inverted side perspective view of the high pressure fill valve FIG. 11;

FIG. 13 is an upward side perspective view of the regulator valve assembly top housing member;

FIG. 14 is an inverted side perspective view of the opposite side of the regulator valve assembly top housing member of FIG. 13;

FIG. 15 is an enlarged scale, fragmentary assembly view of the regulator valve assembly, showing how the top housing member of FIGS. 13 and 14 is operationally mated to the bottom housing member of FIGS. 7 and 8;

FIG. 16 is an enlarged and exploded fragmentary perspective view of the preferred regulator valve assembly showing how the bottom and top halves are mated together;

FIG. 17 is a top perspective view of the preferred regulator valve assembly;

FIG. 18 is a longitudinal sectional view taken generally along line 18--18 of FIG. 17;

FIG. 19 is a vertical sectional view taken generally along line 19--19 of FIG. 16 in the direction of the arrows;

FIG. 20 is a vertical sectional view taken generally along line 20--20 of FIG. 18 in the direction of the arrows;

FIG. 21 is an enlarged, fragmentary, exploded perspective view of the preferred seltzer infusion valve assembly;

FIG. 22 is a bottom perspective view of the seltzer infusion valve, taken generally along line 22--22 of FIG. 21 in the direction of the arrows;

FIG. 23 is an enlarged bottom plan view of the flange conical gasket;

FIG. 24 is an enlarged top plan view of the gasket or FIG. 23;

FIG. 25 is an enlarged, fragmentary, longitudinal sectional view of the infusion valve taken generally along line 25--25 of FIG. 21, in the direction of the arrows;

FIG. 26 is a block diagram of the electrically actuated dispensing pressurization/depressurization system;

FIG. 27 is an enlarged, exploded, fragmentary, assembly view of the removable syrup concentrate/cannabinoid pods;

FIG. 28 is an exploded, fragmentary elevational view or the preferred seltzer bottle and its associated non-fragmenting housing;

FIG. 29 is a bottom plan view of the lower half portion or the non-fragmenting housing;

FIG. 30 is a longitudinal sectional view taken generally along line 30--30 of FIG. 28;

FIG. 31 is a vertical sectional view taken generally along line 31--31 of FIG. 28;

FIG. 32 is a vertical sectional view taken generally along line 32--32 of FIG. 28 in the direction of the arrows;

FIG. 33 is an enlarged front perspective view of the preferred siphon tube diffuser, the rear being a mirror image thereof; and, FIG. 34 is an enlarged front elevational view of the preferred siphon tube diffuser.

### DETAILED DESCRIPTION OF THE PREFERRED EMBODIMENT

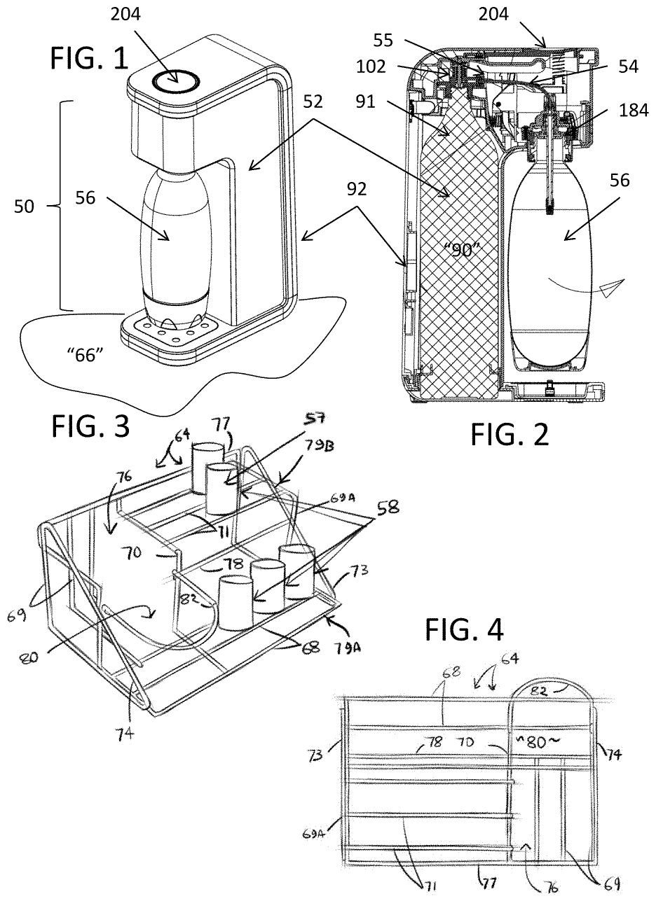

With initial reference now directed to FIGS. 1-5 of the appended drawings, a home soda dispensing system constructed in accordance with the best mode of the present general inventive concept has been designated by the reference numeral 50. System 50 preferably comprises a source of carbon dioxide 52 which charges a seltzer dispenser, broadly designated by the reference numeral 56. An elongated, resilient plastic hose 54 fitted with suitable conventional quick connect fittings 55 is adapted to couple the gas source 52 to the seltzer dispenser 56 for charging. As explained hereinafter, the dispenser 56 should be pre-filled with water prior to carbonation or charging. A plurality of removable flavor pods 58 pre-filled with syrup concentrate and/or water-soluble cannabinoids provide numerous user selectable flavors. In the best mode the CO₂ source 52, the soda dispenser 56, and each of the removable flavor pods 58 are conveniently stored in a rigid, supporting storage rack, generally designated by the reference numeral 64, which may be placed upon a counter top 66 or a similar convenient flat supporting surface.

Rack 64 is preferably comprised of numerous appropriately configured plastic coated steel or stainless steel wire segments as shown in the figure. The bottom of the rack is comprised of a plurality of generally horizontally extending members 68 which are reinforced at their ends and which are united with generally L-shaped corner members 69. Upper horizontal rack elements 71 extend in a plane above the lower elements 68 between an intermediate corner member 70 and an outer corner frame member 69A. Reinforcement is achieved with the two inclined, wedge shaped side members 73 and 74.

A first compartment, generally designated by the reference numeral 76, is defined between top rear frame rail 77, reduced height frame rail 78, corner member 70 and side wedge member 74. Compartment 76 may receive and temporarily store the gas source 52. An adjacent compartment, generally designated by the reference numeral 80, is formed between rail 78 and an outwardly projecting, generally horizontally disposed loop member 82. The seltzer dispenser 56 may be captivated within the rack compartment 80 upon the bottom supportive surface provided by the horizontal rack members 68, being restrained by rack loop 82. In the preferred embodiment, gas source 52 and seltzer dispenser 56 are both be enclosed in a plastic housing 92 that subsequently fits into compartments 76 and 80.

Upper and lower removable flavor pod shelves 79B and 79A are disposed adjacent compartments 76 and 80 respectively.

Upper shelf 79B is generally defined by the upper horizontal rack elements 71. Similarly, lower shelf 79A is defined by the horizontal frame elements 68, to the right (as viewed in FIG. 3) of loop 82. As viewed in FIG. 3, the generally cylindrical pods 58 may thus be disposed in orderly rows at the bottom of the rack or at the top of the rack, adjacent the seltzer compartment 80 and the pressure vessel compartment 76. Once the loaded rack is appropriately disposed in a convenient place upon the kitchen counter-top 66, for example, the entire system 50 will thus be conveniently stored in an aesthetically pleasing, orderly manner. In order to operate the device, and as will hereinafter be explained in detail, the seltzer dispenser 56 infusion valve is actuated by pressing button 204 permitting gas charging of the water contained within dispenser 56. Afterwards, a selected flavor pod 58 may be removed from the rack and “snapped in” to a removably-mating element associated with dispenser 56 where concentrate within the selected pod 58 will be mixed and subsequently directed to the discharge tube. Once the electrically-actuated dispensing pressurization system (FIG. 26) associated with the seltzer bottle assembly is activated, a consumable cannabinoid-infused carbonated beverage will be quickly “home-made” for immediate consumption.

With reference now primarily directed to FIGS. 3, 5 and 27, the removable flavor pods 58, which are injection molded from biodegradable plastic or the like, are generally cylindrical. Each flavor pod comprises a flat rear portion adapted to rest upon the shelves of the rack 64, and a flat, circumferential surface 57 upon which suitable flavor-designating labels may be adhesively attached. The removable flavor pods 58 each incorporate a quick disconnect element threadably mounted and sealed to the flat rear portion and adapted to provide fluid communication from seltzer dispenser 56 to a first inner chamber of pod 58. A hole in circumferential surface 57 is provided for a discharge tube in sealed communication with a second inner chamber of pod 58. A flavor pod 58 is “snapped in” to the fluid connecting element on housing 92 and thereafter the contents of pod 58 may be mixed and dispensed merely by actuating a switch to start the flow of seltzer from dispenser 56 to flavor pod 58. In accordance with the best mode, the preferred mixture ratio of water to concentrate is 24:1 and is maintained by mixing elements within flavor pod 58.

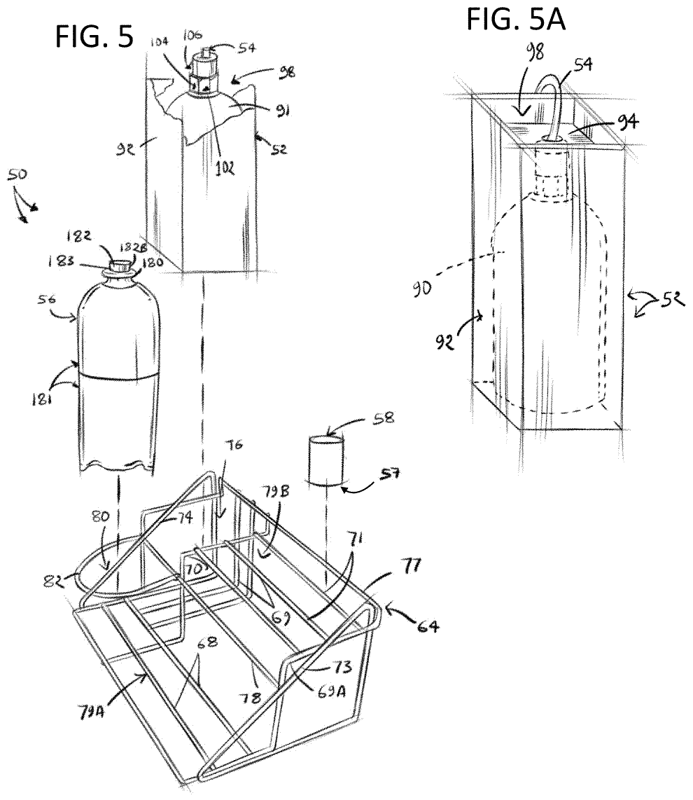

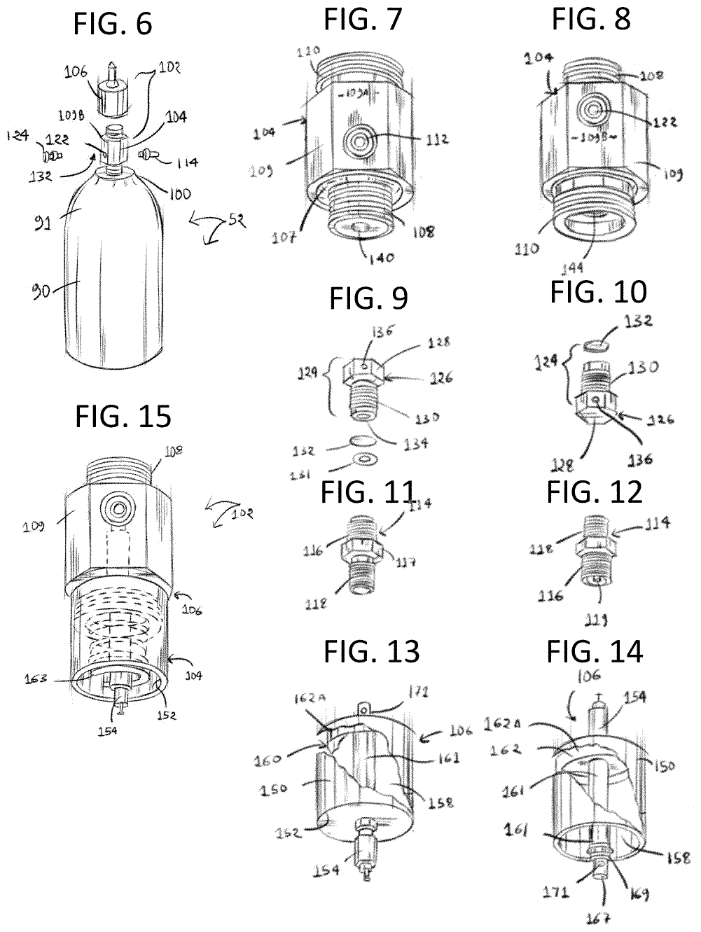

With particular attention now directed to FIGS. 1, 2, 5, 5A and 6, the gas source 52 preferably comprises a conventional, high pressure gas vessel 90 which is attractively packaged within an ergonomic and aesthetic, enclosure housing 92. Housing 92 is configured to readily fit within the general confines of rack compartment 76 previously described, and in a preferred configuration compartments 76 and 80, and it includes a recessed top 94 which substantially covers gas vessel 90. Hose 54 passes through recessed top 94. As best viewed in FIG. 5A, the recessed top 94 defines compartment 98 for containing the charging hose 54 and other tubing and/or electrical wiring. The reduced diameter surface region 91 of the pressure vessel 90 terminates in a high-pressure orifice 100 (FIG. 6) which threadably receives a regulator valve assembly, generally designated by the reference numeral 102, which outputs low pressure gas for charging the seltzer dispenser 56.

With primary attention now directed to FIGS. 7 through 20 collectively, the regulator assembly 102 comprises a bottom housing 104 which is threadably coupled to the gas vessel output orifice 100, and a cooperating top housing 106 mated to the bottom housing 104. The bottom housing 104 comprises a threaded lower end 108 adapted to be threadably coupled to vessel orifice 100, and a spaced-apart larger diameter upper threaded portion 110 adapted to be threadably mated to the top housing member 106. A sealing O-ring 107 is associated with threaded end 108. A nut-like, multi-faceted intermediate body portion 109 is integral with lower and upper threaded portions 108 and 110.

Body portion 109 of regulator valve assembly bottom housing 104 comprises a facet 109A (FIG. 7) provided with a suitable threaded orifice 112 for mounting a high-pressure fill valve 114 (FIG. 6, 11-12). With reference to FIGS. 11 and 12, the high pressure fill valve 114 is of conventional construction, comprising a larger diameter portion 116 adapted to be threadably fitted within orifice 112, an integral lower diameter portion 118 adapted to be coupled to a high pressure gas source, an intermediate nut portion 117 which aids in assembly, and an internal, spring biased filling valve member 119 of conventional construction (FIG. 12). Vessel 90 may thus be charged from a high-pressure commercial source of carbon dioxide gas by coupling to fitting 114. Likewise, vessel 90 could be a single-use or recyclable canister.

On the opposite side, an equivalent facet 109B (FIG. 8) includes a similar threaded orifice 122 for receiving a high-pressure relief valve assembly 124 (FIGS. 9, 10). Assembly 124 comprises a fitting 126 having a nut-like cap 128 and an integral threaded shank 130 threadably fitted to orifice 122. The relief valve assembly 124 also comprises a resilient circular rupture disk seal 132 which generally occludes the longitudinal passageway 134 defined in shank 130, by compression against a dead soft copper washer 131. Seal 132 is characterized by a burst pressure of 2800-3000 PSI. It will be noted that cap 128 includes a transverse passageway 136 which is in fluidic communication with passageway 134. In the event that over-pressurization occurs within the high-pressure vessel 90, pressure relief is provided through orifice 122 (FIG. 8), past relief seal 132, and out transverse passageway 136 in a harmless direction tangential to the vessel sides.

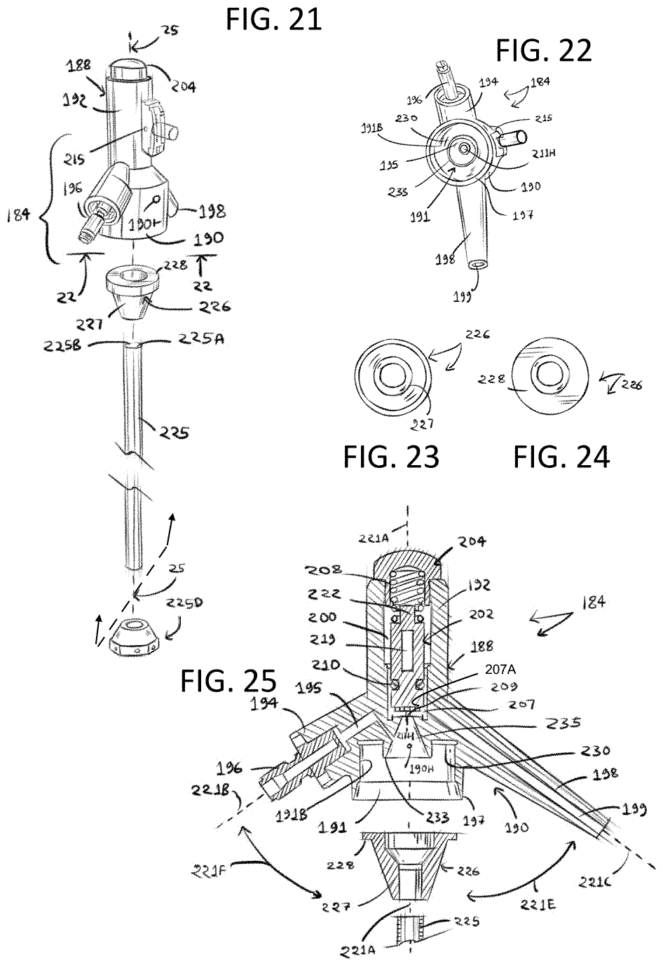

With additional reference directed now to FIG. 18, the bottom housing 104 comprises a lower passageway 140 concentrically extending through threaded bottom 108 which is disposed in fluid-flow communication with a transverse passageway 142 and an upper passageway 144. Passageway 142 interconnects orifices 112 and 122 (FIGS. 7, 8) into which the fill valve 114 and the relief valve 124 are fitted. Upper passageway 144 concentrically extends through the nut body portion 109 and adjacent upper threaded portion 110. Passageways 140 and 144 are separated from one another by a restriction orifice 146. As best viewed by comparing FIGS. 18 and 20, the restriction orifice 146 is concentrically formed in the middle of a restriction 148 having a slight crown 149 whose purpose will be hereinafter described. Nevertheless, at this point it will be apparent that the interior of the vessel 90 may be charged by applying high pressure gas to fitting 114 and thus orifice 142 and passageway 140. And high-pressure venting may occur through the relief valve 124, since it is in fluid flow communication with the vessel interior through passageways 140 and 142 as well.

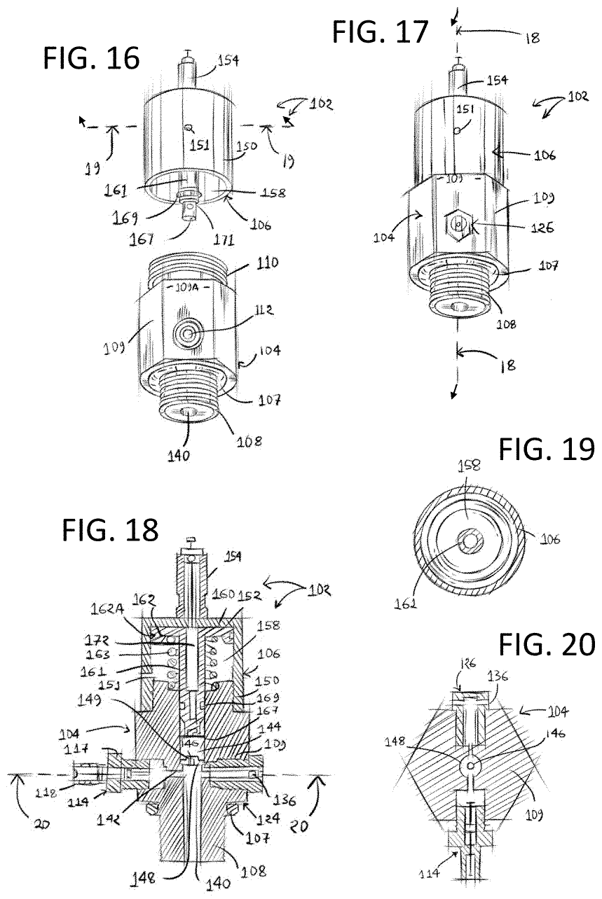

As previously mentioned, the regulator valve assembly also comprises a top housing 106 (FIGS. 13-18). It comprises a tubular body portion 150 which is internally threaded to mate with the threaded top 110 of the bottom regulator housing previously discussed, and it houses an axially displaceable plunger assembly 160 comprising a piston 162 and a stem 161. Piston 162 includes a conventional large O-ring 162A. The top 152 (FIG. 18) integrally includes a low-pressure discharge valve 154 which is in fluid flow communication with that portion of the interior 158 which is immediately above the internal piston 162. The interior cavity 158 is vented to atmosphere by orifice 151 (FIGS. 16, 17) below piston 162. The piston stem 161 terminates in a lower, preferably plastic (e.g., Teflon-brand) seal 167 which, as viewed in FIG. 18, normally contacts crown 149 to block restriction orifice 146. The piston stem 161 is slidably fitted within passageway 144, and it is sealed by an O-ring 169. A spring 163 (FIGS. 15 and 18) disposed within cavity 158 biases the plunger 160 towards the low-pressure gas output valve 154.

High pressure gas escaping through the restriction orifice 146 when the piston is deflected upwardly against the working surface provided by seal 167 is confined beneath O-ring 169, but may enter the transverse orifice 171 for conduction via longitudinal slot 172 (FIG. 18) to a relief position immediately above piston 162 below top 152. A balancing of force between the pressure above the regulator piston 162 and the high pressure transmitted to the seal 167 will thus result in pressure regulation. Low pressure gas may be outputted through the valve 154, which as explained previously, may be snap-fitted to the charging hose 54 for conduction to the seltzer dispenser 56.

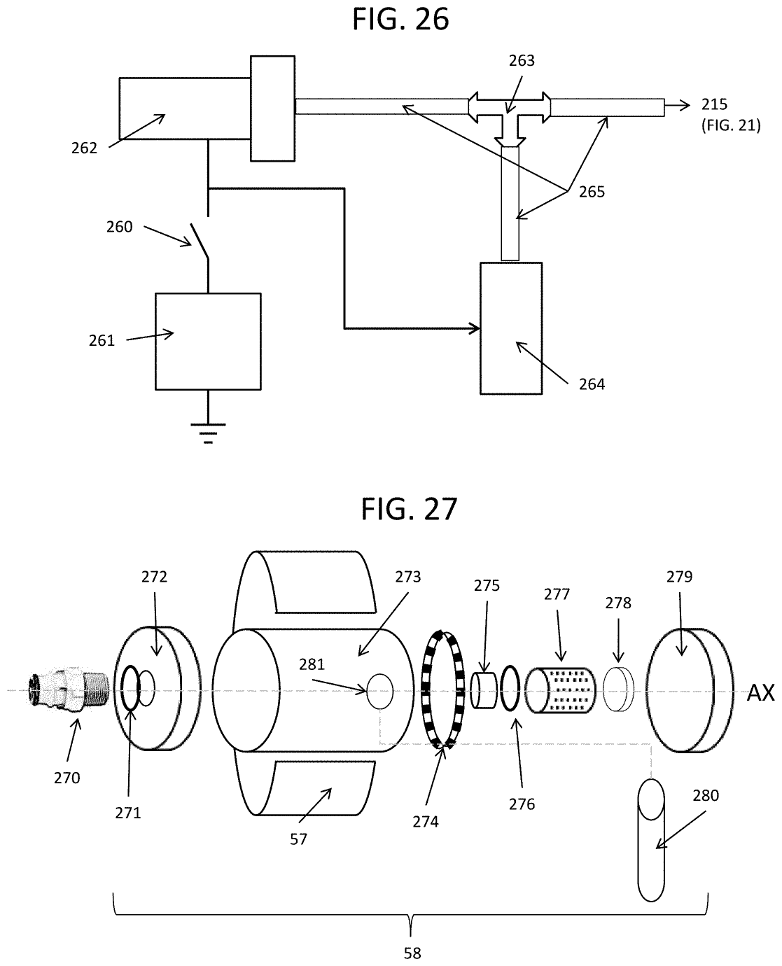

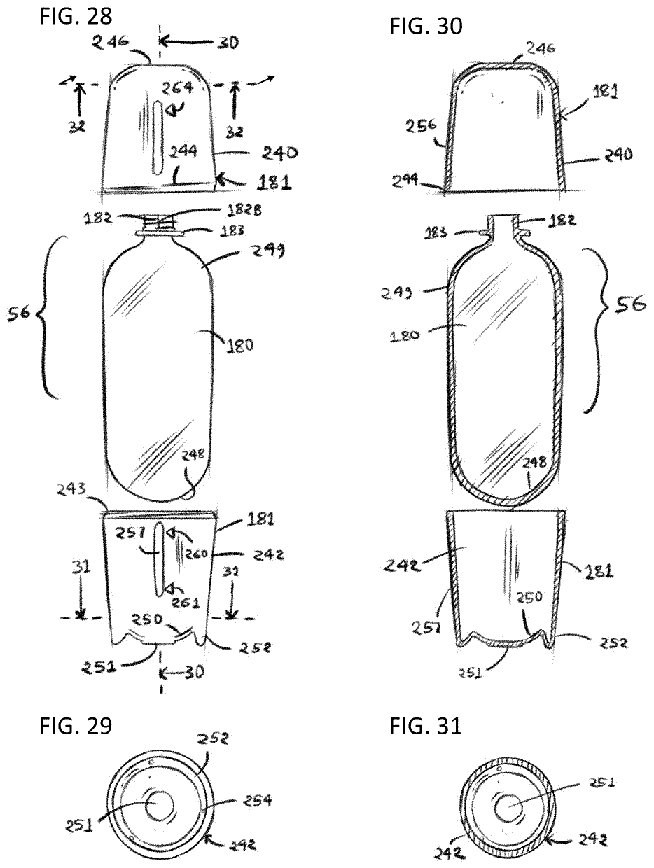

Turning now to FIGS. 5, 21 through 26, and 28-31, the seltzer dispenser comprises a transparent, blow-molded plastic bottle 180 having a threaded neck 182 which may be threadably coupled to an infusion valve assembly, generally designated by the reference numeral 184 (i.e. FIGS. 21-25). Seltzer bottle 180 is optionally housed within a two-piece non-fragmenting housing generally designated by the reference numeral 181 (FIG. 5) to be described in detail hereafter. As seen in FIGS. 5 and 28 the bottle 180 includes a peripheral flange 183 separating the threaded neck 182 from the lower body portion. Conventional safety vent slots 182B are defined in the bottle's threads to vent the bottle as the infusion valve is unscrewed to prevent “popping.”

With reference to FIGS. 21 through 25, the seltzer infusion valve assembly comprises a rigid generally plastic and tubular body 188 comprising a base, generally designated by the reference numeral 190 and an integral, reduced diameter upper tubular portion 192. Base 190 circumscribes a large mouth 191 including threads 191B adapted to be threadably coupled to the threaded bottle end 182 (FIG. 5). Mouth 191 is thus defined by a peripheral annular base 197 which, when the discharge assembly 184 is forcibly threaded to the bottle 180, closely approaches the bottle flange 183 previously described. Body 188 also includes a downwardly directed tubular inlet 194 including a low pressure gas inlet orifice 195 which conducts low pressure gases interiorly of the bottle via a filling check valve 196 coupled to the hose 54 previously discussed. Body 188 likewise includes a barbed tubing port 215 to communicate pressurized air via lumen 225B of siphon tube 225 creating a head pressure for dispensing fluid. Additionally, an integral, downwardly inclined and tubular spout 198 includes an output passageway 199 in fluidic communication with the upper volume 200 (FIG. 25) in which a valve assembly, generally designated by the reference numeral 202 (FIG. 25), is disposed.

With reference to FIGS. 21 and 25, a vent orifice 190H vents the generally conical interior region 235 to atmosphere. A liquid seal is nevertheless maintained when the device is assembled because of flange 228 on gasket 226 to be described later. If a pressure head is present in the bottle, and the user nevertheless unscrews the infusion valve, the gasket is loosened and gas pressure is dissipated though orifice 190H while the screw threads are still at least partially meshed. This safety feature prevents “Champagne-cork” popping phenomena. In addition, further pressure relief is facilitated during unscrewing by vent slots 182B defined in the bottle closure threads. The pressure seal otherwise maintained by the seated or meshed screw threads coupling the infusion valve to the bottle is relieved by slots 182B, which then intercommunicate the bottle interior with the gradually withdrawing mouth 191 without interference from gasket 226.

As best viewed in FIG. 25, the charging valve assembly 202 is restrained via an actuating push button 204 including a reduced diameter threaded portion 205 adapted to be coupled to upper body portion 192. A spring 208 biases a sliding member 209 having an O-ring 210 into region 201 (FIG. 25). When push button 204 is actuated, an actuator seal 207, which is force fitted into recess 207A, abuts valve seat 211 to block communicator orifice 211H. Orifice 211H establishes fluid flow communication between regions 201 and 235.

As seen in FIGS. 21 and 22, the sliding member 209 includes an upper stem 222 which penetrates and restrains spring 208, and a bottom 223 fitted with an O-ring 210 which slides within region 201. Recess 207A defined in bottom 223 (FIG. 25) mounts seal 207. The seal 207, spring 208, sliding member 209, actuating push button 204 and the dual-lumen siphon tube 225 (and other working parts and passageways) are aligned with the longitudinal axis 221A (FIG. 25) of the infusion valve assembly. Inlet 194 has a longitudinal axis 221B, and spout 198 has a longitudinal axis 221C which is coplanar with axis 221B. Axis 221B and 221C both intersect longitudinal axis 221A forming an angle 221E which is between fifty and sixty degrees. In the best mode it is approximately fifty five degrees. This design facilitates compactness of the seltzer infusion valve assembly, and provides an optimum angle for dispensing liquid from the spout into the outlet member permitting fluid communication with the removable flavor pods 58.

A dual-lumen siphon tube 225, which extends downwardly into the bottle beneath the liquid level, is mounted by a gasket 226, and it preferably terminates in a terminal diffuser 225D (FIGS. 21, 33, and 34). The diffuser 225D comprises an apertured disc 225E integral with a central sleeve 224F adapted to be friction fitted to dual-lumen siphon tube 225. In operation, the diffuser will be disposed beneath the water level within the seltzer bottle. The radially spaced apart orifices 225G defined in disc 225E communicate via passageway 224B with the interior lumen 225A of the siphon tube 225. This construction reduces the conduction speed of liquid into the siphon tube during liquid discharge, and it reduces gas admission speed during charging. Further, charging gas is distributed throughout the bottle evenly to increase scrubbing and minimize the need for shaking during the carbonation process. The combined orifice area of the diffuser holes 225G preferably approximates the area size of orifice 211H.

With particular attention now directed to FIGS. 23 through 25, dual-lumen siphon tube 225 which projects from conical region 235 through mouth 191 out of the valve body 188 into the interior of the bottle is preferably coupled with a generally conical, resilient gasket generally designated by the reference numeral 226. Gasket 226 comprises a tubular, tapered portion 227 into which the dual lumen siphon tube 225 is fitted and an increased diameter flange portion 228 which seals the dispenser base 190 to the bottle 180. Mouth 191 of the infusion valve 188 includes an annular recess 230 adapted to receive gasket 226, and a concentrically disposed inner collar 233 enshrouded by the gasket 226 when it is installed. In this fashion the siphon tube will be wedged into region 235 (FIG. 25) immediately adjacent the valve sub assembly 202. Through the construction disclosed, it will be apparent that the gas input orifice 195 will be constrained to deliver its pressure interiorly of the siphon tube (225A) during the charging cycle, since access to atmosphere through orifice 211H and spout 198 is foreclosed when actuating push button 204 is depressed. In other words, through the gasket construction disclosed inputting charging gases are forced through the siphon tube (225A) downwardly into the bottled water during charging, and they rapidly bubble through the water to form a high pressure head at the top of the filled bottle.

With attention now directed to FIG. 26, an electrically actuated fluid dispensing pressurization/depressurization sub-system of the present generally inventive concept comprises an electrical switch 260, power supply 261, which can be either a battery pack or an A.C. wall adapter or the like or some combination thereof, a diaphragm-type motor-driven air pump 262, a molded plastic “T” tubing connector 263, a normally-open (deenergized) electrically actuated solenoid valve 264 and interconnecting tubing 265 for communicating air pressure to port 215 (FIG. 21) of infusion valve assembly 184.

After the water in dispenser 56 has been charged with gas as described in detail hereinabove, and a flavor pod 58 is “snapped in” to the releasable mating fluid communication element on housing 92; depressing dispensing switch 260 will activate pump 262 and close solenoid valve 264. Pressurized air subsequently travels through port 215 in valve body 188 down lumen 225B of siphon tube 225 creating a head pressure within dispenser 56. Since push button 204 will be in an upward position during dispensing, sliding member 209 will also be in its upward position. Thus, communication orifice 211H will be unblocked connecting conical region 235 with regions 200 and 201 thus permitting venting out spout 198 through its passageway 199. The high pressure gas head created at the top of the charged bottle will force carbonated water through lumen 225A of the downwardly projecting siphon tube 225 up into the interior of the valve assembly wherein it is transmitted out through spout 198. Once the desired amount of fluid has been dispensed, switch 260 is released whereupon solenoid valve 264 returns to its normally open state and vents all remaining head pressure to atmosphere having the immediate effect of terminating the fluid flow from dispenser 56 and thus preventing undesired dripping onto counter top 66.

Referring now in particular to FIG. 27, the removable flavor pod assembly is generally designated by the numeral 58. Pod assembly 58 is comprised of a first inner chamber and a second outer chamber arranged concentrically. The first inner chamber is comprised of regulator valve 275, rubber o-ring 276, micro-fenestrated body 277, and end-cap 278. Likewise, the second outer chamber is comprised of releasable fluid communication element 270, rubber o-ring 271, end-cap 272, pod body 273, nucleation element 274 and end-cap 279. A discharge tube 280 is sealably attached to pod body 273 through hole 281 and in fluid communication with the second outer chamber. All of the various components and elements making up pod assembly 58 are assembled along an axis designated as “AX”. Once the components are sealably connected, syrup concentrate including water-soluble cannabis may be introduced under pressure through releasable fluid communication element 270, and regulator valve 275 collecting in micro-fenestrated body 277, where it remains until dispensed. Finally, an adhesive label 57 is circumferentially attached to the outer surface of pod body 273.

When dispensing switch 260 is activated as described above fluid is caused to flow from spout 198 through releasable mating element 270 and into the first inner chamber. Regulator valve 275 which is inserted in micro-fenestrated body 277 and sealed with o-ring 276 passes fluid under pressure into the interstices of micro-fenestrated body 277 forcing the high-viscosity concentrate contained therein to pass through the micro-fenestrations and into the second outer chamber. Once the concentrate has passed thereto, the pressurized fluid, having a much lower viscosity then the concentrate, sprays through the micro-fenestrations into the second outer chamber. At this point, the fluid and concentrate come in intimate contact with the nucleation element 274. The nucleation sites on nucleation element 274 causes a portion of the dissolved gas in the fluid to rapidly come out of solution vigorously mixing the fluid and concentrate in the second outer chamber. As the second outer chamber fills with this mixture, it begins to overflow into discharge tube 280 whereupon it is dispensed into a waiting glass, vessel or container. Once dispensed in this fashion it is ready for immediate consumption. The preferred mixture ratio of 24:1 (water to concentrate) may be controlled by selecting regulator valve 275, micro-fenestrated body 277 (size and number of fenestrations) and operating fluid pressure. In this way, pod 58 in combination with the system described herein above can produce any manner or variety of carbonated beverages each perfectly mixed to optimize flavor and enjoyment.

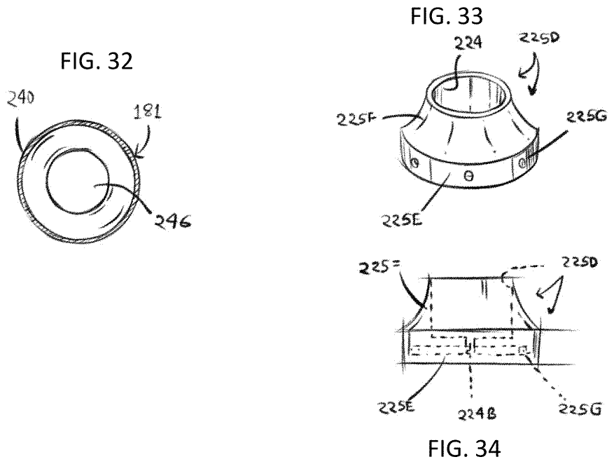

With attention directed now to FIGS. 28 through 32, the seltzer dispenser 56 stores water within a blow molded preferably transparent plastic bottle 180. The optional non-fragmenting housing 181 comprises an upper generally cup-like half 240 adapted to be threadably coupled to cooperating, generally cup-like lower half 242. Suitable threads 244 are simply mated to threads 243 in lower half 242. The neck of the bottle will project upwardly through an orifice 246 defined in the top of half 240. The generally convex bottom 248 of bottle 180 will be gently urged into contact with a generally concave interior bottom 250 of non-fragmenting housing half 242. The concave bottom 250 is surrounded by an annulus 252 having a bottom in which preferably three, radially spaced-apart, moisture venting holes 254 are defined (FIG. 29). Bottom 250 also comprises a central pressure relief orifice 251. The bottle bottom 248 is preferably blow molded a thinner gauge than the top 249 or the bottle sides.

Through the bottle construction disclosed, failure of the bottle will result in destruction of bottle 180 since bottom 248 is thinner. Escaping gases from bottle failure will thus be safely vented through orifice 251 and relief orifices 254. In addition, failure of the bottle walls or sides will result in venting and dissipation through orifices 254, and through a pair of inspection slots 256 and 257.

Inspection slots 256 and 257 enable the user of the device to view the interior of the bottle. The lower inspection slot 257 is associated with a pair of marker tabs 260 and 261 respectively disposed adjacent the slot's top and bottom. A similar marker tab 264 is defined adjacent the top of upper inspection slot 256. The bottom marker tab 261 indicates the lowest level and top marker tab 264 indicates the highest level to which water should be added. Level marker 260 is in the middle; it is ideal for producing a wine cooler drink or other special formula drinks. In the latter case, wine, for example, may be filled to the level indicated by marker tab 261, and then water is added to level 260 prior to gas charging. If it is desired merely to produce club soda, by way of example, water is filled to full level marker 264 prior to bottle charging. Soda may then be consumed “straight,” or it may be blended with a selected syrup and/or water-soluble cannabinoid using a removable flavor pod prior to discharging to a suitable glass and producing a desired carbonated beverage.

It will thus be apparent that the system disclosed herein, taken as a whole, comprises a cannabinoid-infused carbonated beverage system which functions without normally hidden parts disposed beneath or behind cabinet level. Special cabinetry or special fixtures will not be required for successful use of the invention. Moreover, it will be apparent that the system may be used in many ways to produce drinks satisfying a variety of different user tastes or requirements.

From the foregoing, it will be seen that this present generally inventive concept is one well adapted to obtain all the ends and objects herein set forth, together with other advantages which are inherent to the structure.

It will be understood that certain features and subcombinations are of utility and may be employed without reference to other features and subcombinations. This is contemplated by and is within the scope of the claims.

The above described embodiments are set forth by way of example and are not for the purpose of limiting the scope of the present general inventive concept. It will be readily apparent that obvious modifications, derivations and variations can be made to the embodiments without departing from the scope of the invention. Accordingly, the claims appended hereto should be read in their full scope including any such modifications, derivations and variations.

What is claimed is:

1. A beverage carbonating system, which includes:
a container having a fluid therein;
a carbonating charging device operably connected to said container for delivering carbonated gas thereto;
a pressure source operably connected to said container for delivering a predetermined amount of pressure within said container to cause a predetermined amount of carbonated fluid to be dispensed therefrom through a pod receiving open surface; and
a pod having a beverage forming ingredient therein which is configured to sealably connect to said pod receiving open surface and has an outlet for a formed beverage fluid to exit therefrom.

2. A beverage carbonating system of claim 1, wherein said beverage forming ingredient includes a cannabinoid.

3. A beverage carbonating system of claim 1, wherein said pod is one of reusable and disposable.

4. A beverage carbonating system of claim 1, which further includes an integrated regulator and output valve assembly connected to said container.

5. A beverage carbonating system of claim 4, wherein said integrated regulator and output valve assembly is configured to be coupled by an elongated fitting-equipped flexible cable to said container.

6. A beverage carbonating system of claim 1, said beverage forming ingredient including one of a plurality syrup flavors, each comprising internal proportional mixing element and a flavor concentrate.

7. A beverage carbonating system of claim 3, wherein said pod is further characterized to be a releasably locking connection.

8. A beverage carbonating system of claim 3, wherein said pod is biodegradable.

9. A pod for use in a carbonating system, which includes:
a first inner chamber and a second outer chamber arranged generally concentrically, said first inner chamber including a regulator and said second outer chamber including a fluid releasor and nucleator.

10. A pod according to claim 9, wherein said regulator includes a regulator valve, a rubber o-ring, a micro-fenestrated body, and an end-cap.

11. A pod according to claim 9, wherein said second outer chamber includes a releasable fluid communication element, a rubber o-ring, end-cap, a pod body, nucleation element and an end-cap.

12. A pod according to claim 9, wherein said pod body includes an outlet and a discharge tube sealably connected to said outlet and in fluid communication therewith.

13. A pod according to claim 9, which includes a syrup concentrate including a water-soluble cannabinoid.

14. A pod according to claim 13, wherein said regulator includes a regulator valve, a rubber o-ring, a micro-fenestrated body, and an end-cap, said second outer chamber includes a releasable fluid communication element, a rubber o-ring, end-cap, a pod body, nucleation element and an end-cap and said syrup concentrate including said water-soluble cannabinoid is disposed in micro-fenestrated body where it remains until dispensed.

15. A pod according to claim 9, wherein said pod is one of reusable and disposable.

16. A pod according to claim 10, which includes a beverage forming concentrate wherein a predetermined mixture ratio of water to said beverage forming concentrate is produced by said regulator valve, said micro-fenestrated body and operating fluid pressure.

17. A pod according to claim 9, which includes a snap-fit connector.

18. A pod according to claim 9, wherein said pod is biodegradable.

19. A pod according to claim 9, wherein said pod is reusable.

20. A pod for use in a beverage forming system, which includes:
a housing having a beverage forming concentrate including a water-soluble cannabinoid.
